(19) United States
(12) Patent Application Publication
(10) Pub. No.: US 2008/0024051 A1
(43) Pub. Date: Jan. 31, 2008

(54) IMAGE DISPLAY DEVICE

(76) Inventors: Hiroyuki Tachihara, Ooamishirasato (JP); Akira Hatori, Chiba (JP); Noriyuki Oroku, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/829,989

(22) Filed: Jul. 30, 2007

(30) Foreign Application Priority Data
Jul. 31, 2006 (JP) 2006-209035

(51) Int. Cl. H01J 63/04

(52) U.S. Cl. 313/495

(57) ABSTRACT

An image display device includes a vacuum envelope which is constituted of a rectangular back substrate which arranges electron sources in the vicinity of intersecting portions of image signal electrodes and scanning signal electrodes, a rectangular face substrate which includes phosphor layers and anodes, and a frame body which is connected to peripheral regions of the respective substrates. A frame width size of a frame body is set such that the long-side frame width is larger than the short-side frame width thus realizing the miniaturization and the reduction of weight of the image display device.

### BACKGROUND OF THE INVENTION

1. Field of the Invention

The present invention relates to a planar image display device which makes use of emission of electrons into vacuum formed between a face substrate and a back substrate.

2. Description of the Related Art

As one self-luminous-type flat panel display (FPD) having electron sources which are arranged in a matrix array, an electric field emission type image display device (FED: Field Emission Display) which uses minute integrative cold cathodes and an electron emission type image display device have been known.

As the cold cathode, there have been known an electron source such as a Spindt-type electron source, a surface-conducive-type electron source, a carbon-nanotube-type electron source, an MIM (Metal-Insulator-Metal) type electron source which is formed by stacking a metal layer, an insulator and a metal layer in this order, an MIS (Metal-Insulator-Semiconductor) type electron source which is formed by stacking a metal layer, an insulator and a semiconductor in this order or a metal-insulator-semiconductor-metal type electron source.

The generally-used self-luminous-type FPD includes a back panel which arranges the above-mentioned electron sources on a back substrate formed of a glass plate, a face panel which arranges phosphor layers and an anode which forms an electric field for allowing electrons emitted from the electron sources to impinge on the phosphor layers on a face substrate formed of a glass plate and a frame body which holds an inner space defined between both facing panels in to a predetermined distance, wherein the FPD is configured to hold a display space which is defined by both panels and the frame body into a vacuum state. The FPD is constituted by combining a drive circuit with the display panel.

Further, on the back substrate of the back panel, a plurality of scanning signal lines which extends in one direction and is arranged in parallel to each other in another direction orthogonal to one direction and to which scanning signals are sequentially applied to another direction is arranged and, further, on the back substrate, a plurality of image signal lines which extends in another direction and is arranged in parallel to each other in one direction to intersect the scanning signal lines is arranged. Further, in general, the electron sources are arranged in the vicinity of respective intersecting portions of the scanning signal lines and the image signal lines, the scanning signal lines and the electron sources are connected to each other by power supply electrodes, and a current is supplied to the electron sources from the scanning signal lines.

Further, the individual electron source forms a pair with a corresponding phosphor layer so as to constitute a unit pixel. Usually, one pixel (color pixel) is constituted of the unit pixels of three colors consisting of red (R), green (G) and blue (B). Here, in the case of the color pixel, the unit pixel is also referred to as a sub pixel.

In addition to the above-mentioned constitution, in the image display device as described above, in the inside of a display region which is defined by the frame body arranged between the back panel and the face panel, a plurality of distance holding members (spacers) is arranged and fixed. The distance between the above-mentioned both substrates is held at a predetermined distance in cooperation with the frame body. The spacers are formed of a plate-like body made of an insulating material such as glass, ceramics, or a material having some conductivity in general. Usually, the spacers are arranged at positions which do not impede an operation of pixels for every plurality of pixels.

Further, the frame body which constitutes a sealing frame is fixed to respective inner peripheries between the back substrate and the face substrate using a sealing material such as frit glass, and the fixing portions are hermetically sealed thus forming sealing regions. The degree of vacuum in the inside of a display region defined by both substrates and the frame body is set to approximately 10⁻⁵ to 10⁻⁷ Torr, for example.

Scanning-signal-line lead terminals which are connected to the scanning signal lines formed on the back substrate and image-signal-line lead terminals which are connected to the image signal lines formed on the back substrate respectively penetrate the sealing regions defined between the frame body and both substrates. At least one of the scanning signal line lead terminals and the image signal line lead terminals which penetrate the sealing region have distal ends thereof extended to a vicinity of an end surface of the back substrate.

Patent Document 1: JP-A-7-302558

Patent Document 2: JP-A-2004-363075

### SUMMARY OF THE INVENTION

A frame body arranged between both substrates holds a display space which is hermetically sealed by the frame body and both substrates in a vacuum state and, at the same time, holds a distance between both substrates.

Patent document 1 discloses the frame body which can cope with atmospheric pressure, wherein the frame body is configured such that a frame width of each side of the frame body has a maximum width at an intermediate portion thereof and has a minimum width at end portions thereof thus forming an outer-peripheral side surface of each side in a convex shape.

The frame body having such a particular shape as described in patent document 1 may have the possibility of bringing about drawbacks such as the difficulty in taking a material for forming the frame body per se, the increase of a weight of the liquid crystal display device along with the large-sizing of the liquid crystal display device, the expansion of sizes of both substrates. Further, when the frame widths of all sizes of the frame body are uniformly narrowed to overcome the drawbacks which the patent document 1 possesses, there arises the possibility of occurrence of leaking of vacuum. The leaking of vacuum brings about the deterioration of a degree of vacuum in a vacuum display region thus giving rise to a drawback the reliability of the image display device is damaged. Further, when the possibility of occurrence of leaking of vacuum can be eliminated, the narrower a width of the sealing region, the possibility of occurrence attributed to flowing of the sealing material is decreased and hence, the narrowing of the width of the sealing region is desirable.

Accordingly, it is an object of the present invention to provide a highly reliable and prolonged-lifetime image display device which can realize the miniaturization and the reduction of weight and can eliminate the occurrence of leaking of vacuum in a sealing region.

To achieve the above-mentioned object, the present invention is characterized in that a frame width of each side of a frame body having an approximately rectangular shape is fixed, and a long-side frame width and a short-side frame width of the frame body are set to satisfy a relationship of long-side frame width>short-side frame width.

Further, according to the present invention, based on sizes and constitutional materials of substrates, a long-side frame width and a short-side frame width of a frame body having a rectangular shape in cross section are configured to satisfy formulae (1), (2).
δ=5WL⁴/384EI (1)
I=bD³/12 (2)

wherein, δ: deflection quantity, W: distributed load, L: length, E: Young's modulus, I: geometrical moment of inertia, b: thickness, D: width

A self-luminous planar display device is constituted by incorporating an image signal drive circuit, a scanning signal drive circuit and other peripheral circuits into the image display device having such a constitution.

By fixing the frame width of each side of the frame body, there arises no waste in taking a material for the frame body and the frame body can be manufactured at a low cost thus contributing to the large-sizing of products in the years to come. Further, by adopting the frame widths corresponding to lengths of the respective sides, profiles of substrates can be made small thus contributing to the miniaturization of a profile of a product and the reduction of weight of the product. Still further, along with the enhancement of substrate design, the occurrence of leaking of vacuum can be prevented thus realizing the acquisition of the reliable and prolonged-lifetime image display device.

Further, it is possible to suppress the flowing of a sealing material to an undesired portion by controlling a quantity of the sealing material to be used thus enhancing the operability and ensuring the display quality.

### BRIEF DESCRIPTION OF THE DRAWINGS

FIG. 1A and FIG. 1B are views for explaining one embodiment of an image display device of the present invention, wherein FIG. 1A is a plan view as viewed from a face substrate side, and FIG. 1B is a side view of the image display device shown in FIG. 1A;

FIG. 2 is a schematic plan view taken along a line A-A in FIG. 1B;

FIG. 3 is a schematic cross-sectional view of a back substrate taken along a line B-B in FIG. 2 and a schematic cross-sectional view of the face substrate at a portion corresponding to the back substrate;

FIG. 4 is a schematic cross-sectional view of the back substrate taken along a line C-C in FIG. 2 and a schematic cross-sectional view of the face substrate at a portion corresponding to the back substrate;

FIG. 5 is a schematic cross-sectional view of the back substrate taken along a line D-D in FIG. 2 and a schematic cross-sectional view of the face substrate at a portion corresponding to the back substrate; and

FIG. 6 is an explanatory view of an equivalent circuit example of the image display device to which the constitution of the present invention is applied.

### DESCRIPTION OF THE PREFERRED EMBODIMENTS

Hereinafter, an embodiment of the present invention is explained in detail in conjunction with drawings.

### Embodiment 1

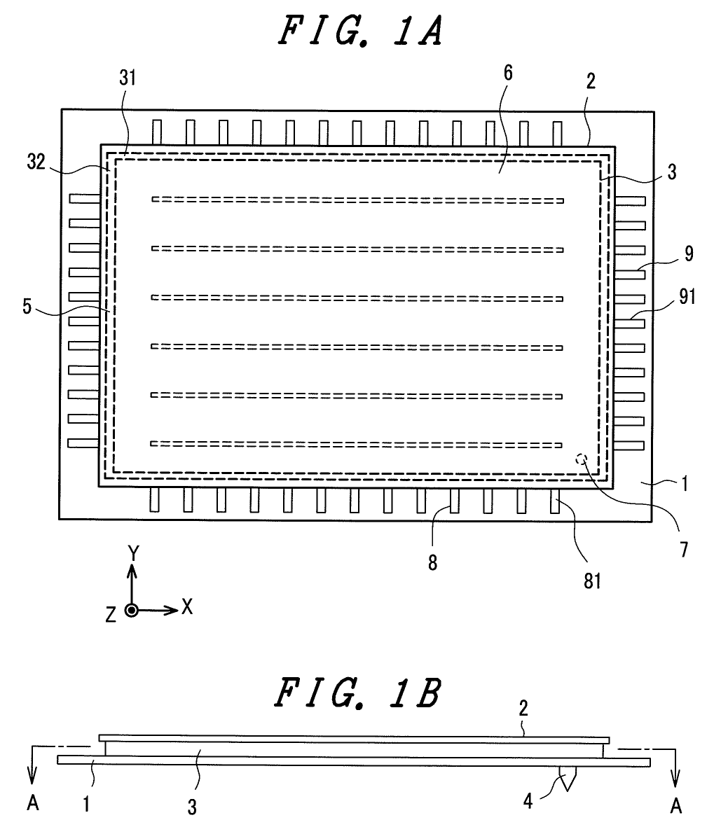

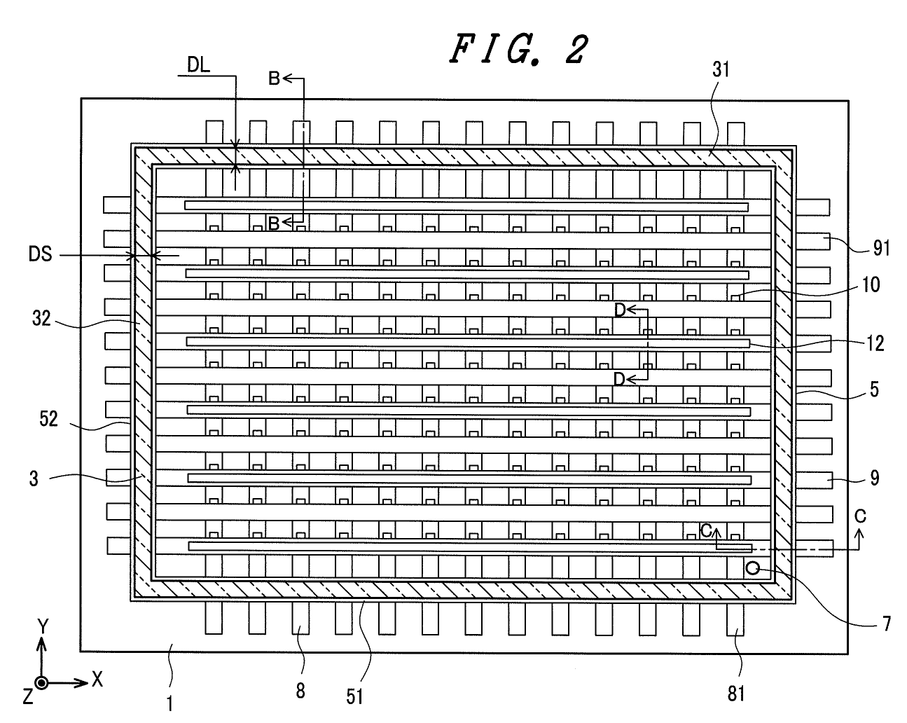

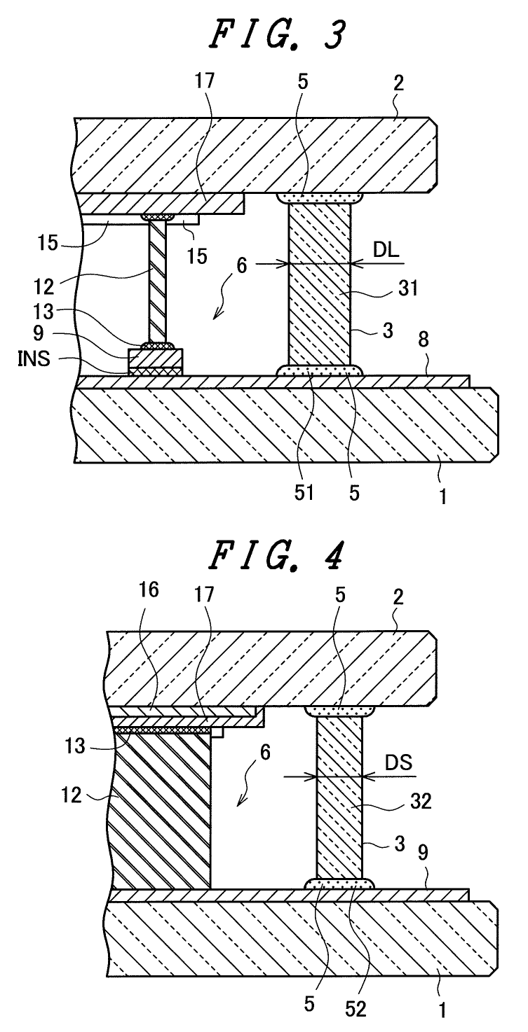

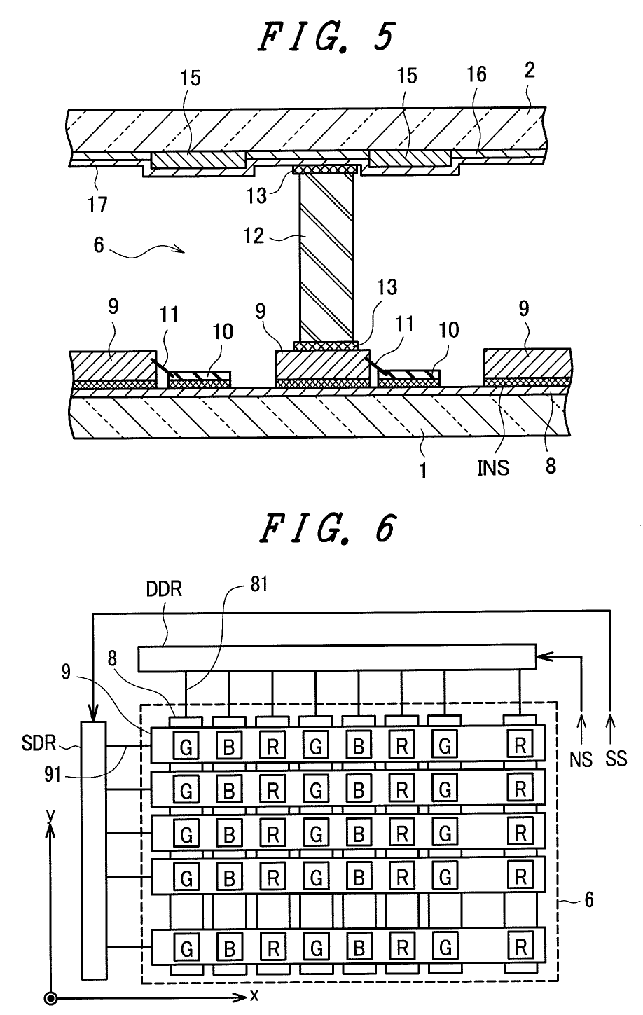

FIG. 1 to FIG. 5 are views for explaining one embodiment of an image display device according to the present invention. FIG. 1A is a plan view as viewed from a face substrate side, FIG. 1B is a side view of the image display device shown in FIG. 1A, FIG. 2 is a schematic plan view taken along a line A-A in FIG. 1B, FIG. 3 is a schematic cross-sectional view of the back substrate taken along a line B-B in FIG. 2 and a schematic cross-sectional view of the face substrate at a portion corresponding to the back substrate, FIG. 4 is a schematic cross-sectional view of the back substrate taken along a line C-C in FIG. 2 and a schematic cross-sectional view of the face substrate at a portion corresponding to the back substrate, and FIG. 5 is a schematic cross-sectional view of the back substrate taken along a line D-D in FIG. 2 and a schematic cross-sectional view of the face substrate at a portion corresponding to the back substrate.

In FIG. 1 to FIG. 5, numeral 1 indicates the back substrate, numeral 2 indicates the face substrate, numeral 3 indicates a frame body, numeral 4 indicates an exhaust pipe, numeral 5 indicates a sealing material, numeral 6 indicates a reduced pressure region including a display region, numeral 7 indicates a through hole, numeral 8 indicates an image signal line, numeral 9 indicates a scanning signal line, numeral 10 indicates an electron source, numeral 11 indicates a connection electrode, numeral 12 indicates a spacer, numeral 13 indicates an adhesive material, numeral 15 indicates a phosphor layer, numeral 16 indicates a light-blocking BM (black matrix) film, and numeral 17 indicates a metal back (an anode electrode) formed of a metal thin film.

Both substrates 1, 2 are formed of a glass plate having a thickness of several mm, for example, approximately 1 to 10 mm. Both substrates are formed in a approximately rectangular shape. The back substrate and the face substrate are stacked with a predetermined distance therebetween. Numeral 3 indicates the frame body. The frame body 3 is formed of, for example, a frit glass sintered body, a glass plate or the like. The frame body 3 is formed by a single body or by a combination of a plurality of members and is formed in an approximately rectangular shape. Further, the frame body 3 is interposed between the above-mentioned both substrates 1, 2.

The frame body 3 has a rectangular cross-sectional shape, and is constituted by combining a pair of frame body members 31 which is arranged on long sides of the approximately rectangular shape and a pair of frame body members 32 which are arranged on short sides of the approximately rectangular shape. Further, frame widths of these frame body members 31, 32, that is, the frame width DL of the frame body members 31 and the frame width DS of the frame body members 32 have the constitutions different from each other and are set to satisfy a relationship of DL>DS. The frame body 3 is inserted between peripheral portions of both substrates 1, 2 and are hermetically joined to both substrates 1, 2. On the other hand, a height of the frame body 3 is set approximately equal to the distance between the substrates 1, 2. The relationship between the frame widths DL, DS is described later. Numeral 4 indicates an exhaust pipe which is fixedly secured to the back substrate 1. Numeral 5 indicates a sealing material. The sealing material 5 is made of frit glass, for example, and joins the frame body 3 and both substrates 1, 2 thus hermetically sealing the space defined by the frame body 3 and both substrates 1, 2. A coating width of the sealing material 5 is set slightly smaller than the frame widths DL, DS of the frame body 3 such that the sealing material projects from the frame widths by appropriate quantities at the time of adhering the frame body 3 to both substrates. Further, a coating height is set uniformly over the whole surface within a coating range.

The space surrounded by the frame body 3, both substrates 1, 2 and the sealing material 5 is evacuated through the exhaust pipe 4 thus holding a degree of vacuum of, for example, 10⁻⁵ to 10⁻⁷ Torr thus forming a reduced pressure region 6 including the display region. Further, the exhaust pipe 4 is mounted on an outer surface of the back substrate 1 as mentioned previously and is communicated with a through hole 7 which is formed in the back substrate 1 in a penetrating manner. After completing the evacuation, the exhaust pipe 4 is sealed.

Numeral 8 indicates image signal electrodes and these image signal electrodes 8 extend in one direction (Y direction) and are arranged in parallel in another direction (X direction) on an inner surface of the back substrate 1. These image signal electrodes 8 hermetically penetrate a first sealing region 51 of a hermetically sealing portion between a frame body member 31 of the frame body 3 and the back substrate 1 from the reduced pressure region 6 and extend to a vicinity of a long-side side end portion of the back substrate 1, and the image signal electrode 8 have distal end portions thereof formed into video signal electrode lead terminals 81. Here, the frame widths DL, DS indicate lengths in the penetrating direction.

Numeral 9 indicates scanning signal electrode. The scanning signal electrodes 9 extend over the image signal electrodes 8 in the above-mentioned another direction (X direction) which intersects the image signal electrodes 8 and are arranged in parallel in the above-mentioned one direction (Y direction). These scanning signal electrodes 9 hermetically penetrate a second sealing region 52 of a hermetically sealing portion between a frame body member 32 of the frame body 3 and the back substrate 1 from the reduced pressure region 6 and extend to a vicinity of a short-side side end portion of the back substrate 1, and the scanning signal electrodes 9 have distal end portions thereof formed into scanning signal electrode lead terminals 91.

Numeral 10 indicates electron sources and the electron sources 10 are formed in the vicinity of respective intersecting portions of the scanning signal electrodes 9 and the image signal electrodes 8. The electron sources 10 are connected with the scanning signal electrodes 9 via connection electrodes 11. Further, interlayer insulation films INS are arranged between the image signal electrodes 8 and the electron sources 10 and the scanning signal electrodes 9.

Here, the image signal electrodes 8 are formed of an Al (aluminum) film, for example, while the scanning signal electrodes 9 are formed of an Ir/Pt/Au film, a Cr/Cu/Cr film or the like, for example. Further, although the above-mentioned electrode lead terminals 81, 91 are provided to both ends of the electrodes, the electrode lead terminals 81, 91 may be provided to only either one of these ends.

Next, numeral 12 indicates spacers, wherein the spacers 12 are made of a ceramic material and are shaped in a rectangular thin plate shape. The spacers 12 are arranged above the scanning signal electrodes 9 every one other line substantially parallel to the above-mentioned frame body 3 in an erected manner, and are fixed to both substrates 1, 2 using an adhesive material 13. Each spacer 12 may fix only one end side thereof to the substrate using the adhesive material 13. Further, with respect to the arrangement of the spacers 12, the spacers 12 are usually arranged at positions where the spacers 12 do not impede the operations of the pixels for every plurality of pixels.

Sizes of the spacers 12 are set based on sizes of substrates, a height of the frame body 3, materials of the substrates, an arrangement interval of the spacers, a material of spacers and the like. However, in general, the height of the spacers is approximately equal to a height of the above-mentioned frame body 3. A thickness of the spacer 12 is set to several tens μm to several mm or less, while a length of the spacer 12 is set to a value which falls within a range from approximately 20 mm to 200 mm. Preferably, a practical value of the length is set to a value which falls within a range from approximately 80 mm to 120 mm.

Further, the spacer 12 possesses a resistance value of approximately 10⁸ to 10⁹ Ω-cm.

In an inner surface of the face substrate 2 to which one end sides of the spacers 12 are fixed, phosphor layers 15 of red, green and blue are arranged in a state that these phosphor layers 15 are defined by a light-blocking BM (black matrix) film 16. A metal back (an anode electrode) 17 formed of a metal thin film is formed in a state that the metal back 17 covers the phosphor layers 15 and the BM film 16 by a vapor deposition method thus forming a phosphor screen.

With respect to these phosphors, for example, Y₂O₂S:Eu (P22-R) may be used as the red phosphor, ZnS:Cu,Al (P22-G) may be used as the green phosphor, and ZnS:Ag,Cl (P22-B) may be used as the blue phosphor. With the constitution of the phosphor screen, electrons radiated from the above-mentioned electron source 10 are accelerated and are made to impinge on the phosphor layer 15 which constitutes the corresponding pixel. Due to such a constitution, the phosphor layer 15 emits light of predetermined color, and the light is mixed with emitted light of color of the phosphor of another pixel thus constituting the color pixel of predetermined color. Further, although the anode electrode 17 is indicated as a surface electrode, the anode electrode 17 may be formed of stripe-like electrodes which are divided for respective pixel columns while intersecting the scanning signal electrodes 9.

As described previously, the frame body 3 is constituted by combining the pair of frame body members 31 which is arranged on long sides of the approximately rectangular shape and the pair of frame body members 32 which is arranged on short sides of the approximately rectangular shape. The respective frame body members 31, 32 have rectangular cross sections. Further, the frame widths of these frame body members 31, 32, that is, the frame width DL of the frame body members 31 and the frame width DS of the frame body members 32 have the constitutions different from each other and are set to satisfy a relationship of DL>DS. The frame widths are specified by following formulae (1) and (2).
δ=5WL⁴/384EI (1)
I=bD³/12 (2)

wherein δ: deflection quantity, W: distributed load, L: length, E: Young's modulus, I: geometrical moment of inertia, b: thickness, D: width

According to the present invention, the frame widths are set such that the pair of frame body members 31 which are arranged on long sides of the approximately rectangular shape and the pair of frame body members 32 which are arranged on short sides of the approximately rectangular shape are set to sizes controllable within the same deflection quantity δ.

For example, in a 32-inch image display device, when an aspect ratio is 16:9, to restrict the deflection of the long-side frame body 31 within a predetermined quantity, it is necessary to set the frame width DL to satisfy DL=9 mm or more. On the other hand, although it may be possible to set the frame width DS of the short-side frame body 32 to satisfy the same 9 mm or more, the increase of weight and the increase of material cost are unavoidable and hence, the quality of the image display device becomes excessive. Accordingly, to take the deflection quantity into consideration, it is unnecessary to set the frame widths DL and DS to the same value and the film width DS may be narrowed to 6 mm based on the above-described formulae (1) and (2). In this manner, the narrowing the frame width DS is advantageous in determining the profile of the product, the weight of the product and the tolerance of product design. Further, a use quantity of the sealing material 5 can be reduced.

FIG. 6 is an explanatory view of an example of an equivalent circuit of the image display device to which the constitution of the present invention is applied. A region depicted by a broken line in FIG. 6 indicates the display region 6. On the display region 6, n pieces of image signal electrodes 8 and m pieces of scanning signal electrodes 9 are arranged in a state that these electrodes intersect each other thus forming matrix of n×m. The respective intersecting portions of the matrix constitute the sub pixels. One group consisting of three unit pixels (or sub pixels) “R”, “G”, “B” in the drawing constitutes one color pixel. Here, the constitution of the electron sources is omitted from the drawing.

The image signal electrodes 8 are connected to the image signal drive circuit DDR through the image signal electrode lead terminals 81, while the scanning signal electrodes 9 are connected to the scanning signal drive circuit SDR through the scanning signal electrode lead terminal 91. The video signal NS is inputted to the image signal drive circuit DDR from an external signal source, while the scanning signal SS is inputted to the scanning signal drive circuit SDR in the same manner.

Due to such a constitution, by supplying the image signal to the image signal electrodes 8 which intersect the scanning signal electrodes 9 which are sequentially selected, it is possible to display a two-dimensional full color image. With the use of the display panel having the constitution described above, it is possible to realize the highly efficient image display device which is operable with a relatively low voltage.

What is claimed is:

1. An image display device comprising:
a back substrate which includes a plurality of first electrodes which extends in the first direction and is arranged in parallel in the second direction which intersects the first direction, an insulation film which is formed in a state that the insulation film covers the first electrodes, a plurality of second electrodes which extends in the second direction and is arranged in parallel in the first direction on the insulation film, and electron sources which are connected to the first electrodes and the second electrodes;
a face substrate which includes phosphor layers of a plurality of colors and acceleration electrodes, and is arranged to face the back substrate in an opposed manner with a predetermined distance therebetween, a frame body which is interposed between the back substrate and the face substrate in a state that the frame body surrounds a display region, the frame body being formed in an approximately rectangular shape with a short-side frame width set narrower than a long-side frame width; and
a sealing material which hermetically seals end surfaces of the frame body and the face substrate and the back substrate respectively in a sealing region.

2. An image display device according to claim 1, wherein the frame body has a rectangular shape in cross section, and the long-side frame width and the short-side frame width of the frame body satisfy formulae (1), (2).
δ=5WL⁴/384EI (1)
I=bD³/12 (2)
wherein, δ: deflection quantity, W: distributed load, L: length, E: Young's modulus, I: geometrical moment of inertia, b: thickness, D: frame width

3. An image display device according to claim 1, wherein a ratio between a long-side length and a short-side length of the frame body is set to 16:9.

4. An image display device according to claim 1 or 2, wherein the image display device includes a plurality of distance holding members which is arranged in the display region substantially parallel to the frame body.

5. An image display device according to claim 1 or 2, wherein the electron source is formed of a thin-film-type electron source array which includes a lower electrode, an upper electrode and an electron acceleration layer which is sandwiched between the lower electrode and the upper electrode, and emits electrons from the upper electrode when a voltage is applied between the lower electrode and the upper electrode.
